(19) United States
(12) Patent Application Publication
(10) Pub. No.: US 2016/0349087 A1
(43) Pub. Date: Dec. 1, 2016

(54) DYNAMICALLY CORRELATING DATA WITH INTERACTIVE GRAPHS

(71) Applicants: Dicky Suryadi, San Diego, CA (US); Johannes Izak Boerhout, San Diego, CA (US)

(72) Inventors: Dicky Suryadi, San Diego, CA (US); Johannes Izak Boerhout, San Diego, CA (US)

(73) Assignee: AKTIEBOLAGET SKF, GOTEBORG (SE)

(21) Appl. No.: 14/721,999

(22) Filed: May 26, 2015

(51) Int. Cl. G01D 7/00; G01H 17/00

(52) U.S. Cl. CPC G01D 7/00; G01H 17/00

(57) ABSTRACT

A computing systems, computer-readable medium, and method for correlating data. The method includes displaying a first data set in a primary graph having a time-based axis. The first data set is collected from a machine by a first sensor. The primary graph includes a plurality of data points representing the first data set. The method also includes receiving a selection of a selected data point of the plurality of data points, correlating the selected data point with a second data set, and displaying a secondary graph representing the secondary data set.

### BACKGROUND

Vibration data is collected from vibration sensors mounted at one or more points on industrial machines, such as motors. The vibration data collected may include waveforms, and may provide insight into the functioning, wear, etc. of the machine or a component thereof. Such data may be recorded periodically, for relatively short durations (e.g., a few seconds each day) and may be stored, processed, analyzed, etc.

In many cases, the data collected may later be processed and presented in graphical form. Various types of graphs are used by vibration analysts to evaluate the condition of the machinery based on the collected data. When a graph shows data from a point (i.e., a physical location on a machine), and the vibration analyst opens another one or more graphs of the same or different type, showing data from one or more different points, the analyst may correlate the graphs so that they all show data taken at the same date-time. For example, one graph may provide a date-time axis (e.g. a trend plot), and the other graphs may correspond to data collected at or around this same date-time. Generally, the analyst accomplishes this correlation of two sets of data by searching for the desired data manually and then opening a graph for that data. Another method is for the program to pre-define the correlation between graphs. While both of these approaches may be suitable, in some cases, either or both may be inefficient or inflexible.

### SUMMARY

Embodiments of the disclosure may provide a method for correlating data. The method includes displaying a first data set in a primary graph having a time-based axis. The first data set is collected from a machine by a first sensor. The primary graph includes a plurality of data points representing the first data set. The method also includes receiving a selection of a selected data point of the plurality of data points, correlating the selected data point with a second data set, and displaying a secondary graph representing the secondary data set.

Embodiments of the disclosure may further provide a computing system including one or more processors and a memory system including one or more non-transitory, computer-readable media storing instructions that, when executed by at least one of the one or more processors, cause the computing system to perform operations. The operations include displaying a first data set in a primary graph having a time-based axis. The first data set is collected from a machine by a first sensor. The primary graph includes a plurality of data points representing the first data set. The operations also include receiving a selection of a selected data point of the plurality of data points, correlating the selected data point with a second data set, and displaying a secondary graph representing the secondary data set.

Embodiments of the disclosure may also provide a non-transitory, computer-readable medium storing instructions that, when executed by at least one processor of a computing system, cause the computing system to perform operations. The operations include displaying a first data set in a primary graph having a time-based axis. The first data set is collected from a machine by a first sensor. The primary graph includes a plurality of data points representing the first data set. The operations also include receiving a selection of a selected data point of the plurality of data points, correlating the selected data point with a second data set, and displaying a secondary graph representing the secondary data set.

It will be appreciated that the foregoing summary is intended merely to introduce certain aspects of the disclosure. These and other aspects are more fully described below. As such, this summary is not intended to be limiting on the claims.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for correlating graphs, according to an embodiment.

FIG. 2 illustrates a visualization of a primary graph and two correlated secondary graphs, according to an embodiment.

FIGS. 3A and 3B illustrate two sensor systems for collecting vibration data from a machine, according to an embodiment.

FIG. 4 illustrates a schematic view of a computing system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

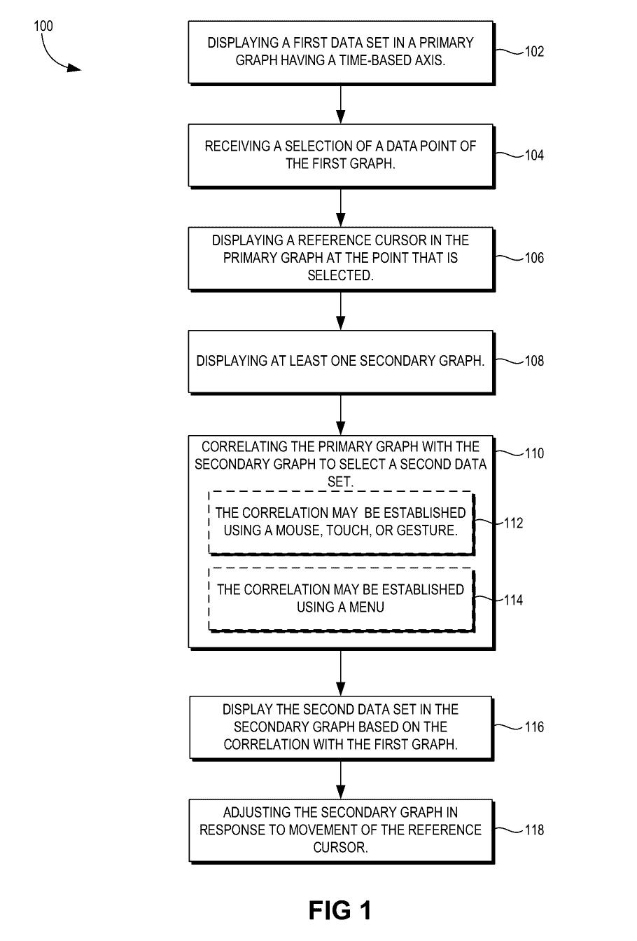

FIG. 1 illustrates a method 100 for correlating data, such as vibration data, e.g., in graphical displays, according to an embodiment. The method 100 may be executed by operation of a processor, as will be described in greater detail below. Thus, the method 100 may include the processor causing a display device (e.g., a computer monitor) to display a first data set in a primary graph having a time-based axis, as at 102. For example, the axis, which may be the horizontal axis, may be a date-time axis, which may indicate when data was collected for a sensor at a location (or “point”) on a machine.

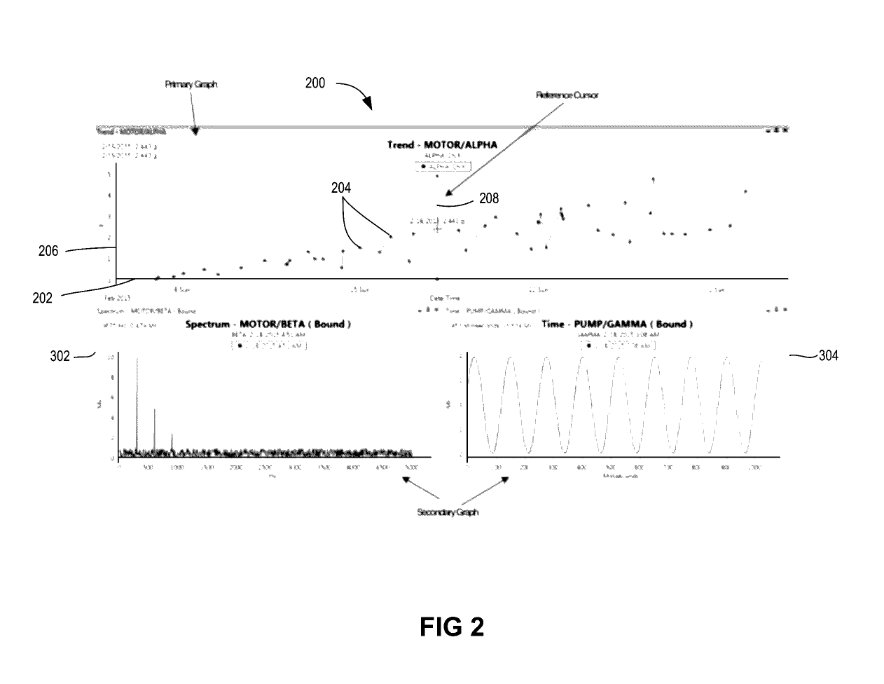

FIG. 2 illustrates a visualization of a correlated primary graph 200 and two secondary graphs 302, 304, according to an embodiment. As shown, the horizontal axis 202 of the primary graph 200 shows date-time, although, in other embodiments, the horizontal axis 202 may employ other units. Data points 204 from the first data set are plotted in the primary graph 200, showing a value measured at a particular date-time, e.g., for a relatively short duration in comparison to the overall date-time span (e.g., seconds or minutes as compared to days, weeks, months, years, etc.). It will be appreciated that in various embodiments, the vertical axis 206 may provide any measured value of relevance, such as maximum amplitude, highest-energy frequency, acceleration (g), as shown, etc.

Referring to FIGS. 1 and 2, the method 100 may also include receiving a selection of a data point 204 of the primary graph 200, as at 104. The selection may be received by way of any suitable input device. In one example, a mouse may be employed by a user to indicate a data point 204 of the first graph 200. In other embodiments, the processor may recognize a touch on a touchscreen, a swipe, a voice command, or any other input capable of indicating a data point 204 on the first graph 200. In other embodiments, a pop-up window, call-out box, drop-down menu, etc. may be employed by a user to select a data point 204 of the first graph 200.

The method 100 may also include displaying a reference cursor 208 in the primary graph 200 at the data point 204 that was selected, as at 106. This may provide visual feedback to a user that the processor has recognized the selection of the intended data point 204 (and/or indicate to the user that an unintended data point has been selected, so the user may adjust). The reference cursor 208 may also provide a basis from which to display more-detailed information (e.g., the date-time may be precisely displayed, potentially along with additional details about the data collection at this point).

With the data point 204 selected, and before, during, or after displaying the cursor 208, the method 100 may include displaying one or more secondary graphs (e.g., the two secondary graphs 302, 304). The secondary graphs 302, 304 may initially be empty, but may be configured to display a second data set that is different from the first data set displayed the primary graph 200, as will be described below. The secondary graphs 302, 304 may be considered “secondary” in that the second data set displayed therein is selected based on a correlation with the primary graph 200. The method 100, along with (e.g., before, during, or after) displaying the secondary graph, may set properties for the secondary graph, such as identifying a sensor from which data will be selected, selecting a type of data (e.g., domain) to display, setting a window size, resolution, etc.

The second data set to be displayed in the secondary graphs 302, 304 may thus be different from the data displayed in the primary graph 200 in source, domain, and/or the like. For example, the secondary graphs 302, 304 may display frequency domain information and/or waveform information, respectively, as shown. Further, the second data set may be collected from the same sensor as the data displayed on the primary graph 200. However, the second data sets displayed in the secondary graphs 302, 304 may also or instead be from a different sensor located at a different position (i.e., “point”) on the machine, or on a different machine. Further, the illustrated two secondary graphs 302, 304 may or may not be configured to display the same second data sets, e.g., depending on the property settings of the secondary graphs 302, 304.

The method 100 may also include correlating the primary graph 200 with the one or more secondary graphs 302, 304 to select the second data set, as at 110. For example, the selected data point 204 of the primary graph 200 may be associated with information collected at a particular date-time. The processor may thus select the second data set from a database of available information, with the second data set being selected based on it having been collected at or around the selected date-time, according to the properties set for the secondary graphs.

In a specific example, the date-time for one sensor may be selected. The processor may then find waveform, frequency, or another type of data that was collected at that date-time, e.g., according to properties established for the secondary graph(s). The processor may then perform any signal processing functions, if needed, to convert the stored information for the date-time into a form specified by the secondary graphs 302, 304 (e.g., a Fourier transform).

In an embodiment, the correlation may be established using a mouse, touch, or gesture, as indicated at 112 (FIG. 1). For example, a user may click on the data point 204 (as identified by the reference cursor 208), and then drag the reference cursor 208 and/or the data point 204 into a window established for the secondary graph (e.g., the second graph 302). Thus, the correlation may be based on a location of the selected data point 204 in the primary graph 200, prior to moving the selected data point 204 via the mouse-drag (or any other input). In another embodiment, a menu may be employed to initiate the correlation, as indicated at 114. With the correlated data set selected, the method 100 may proceed to displaying the secondary graph(s) 300 based on the correlation with the primary graph 200, as at 116.

In some cases, the user may adjust the position of the reference cursor 208, e.g., to select another date-time for analysis. Accordingly, the method 100 may include adjusting the secondary graphs 302, 304 in response to movement of the reference cursor, as at 118. To do so, the processor may again perform a correlation of the data for the primary and secondary graphs 200, 300, e.g., as at 110.

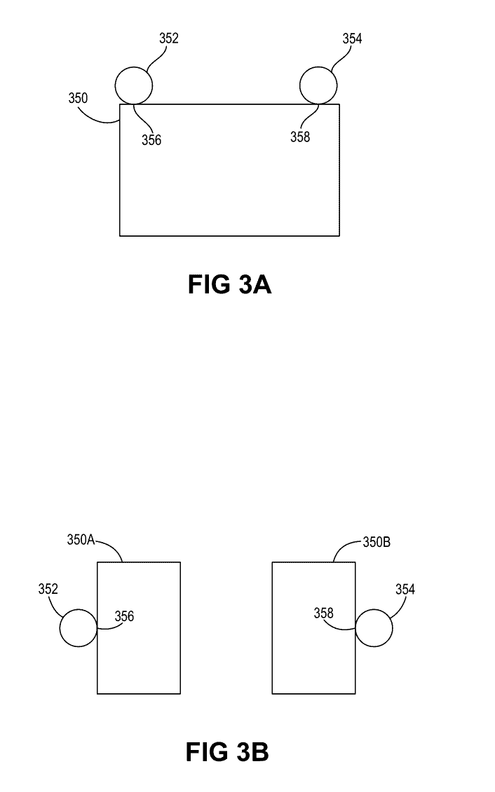

FIG. 3A illustrates a sensor system for collecting vibration data from a machine 350, according to an embodiment. The sensor system may include two or more sensors (two are shown: 352, 354), which are located at different physical locations or “points” (e.g., points 356, 358). Accordingly, the sensors 352, 354 may be configured to measure vibration data (e.g., displacement versus time) or other data relevant to the operation of the machine 350. The first data set, as described above, may include data collected from the first sensor 352, but not the second sensor 354, while the second data set may include data collected from the second sensor 354, but not the first sensor 352.

Similarly, FIG. 3B illustrates a sensor system for collecting vibration data from two machines 350A, 350B, according to an embodiment. The point 356 may be at the first machine 350A, while the second point 358 may be on the second machine 350B, and the first and second sensors 352, 354 may be located at the first and second points 356, 358, respectively. As such, the sensors 352, 354 may collect the first and second data sets from the first and second machines 350A, 350B, respectively.

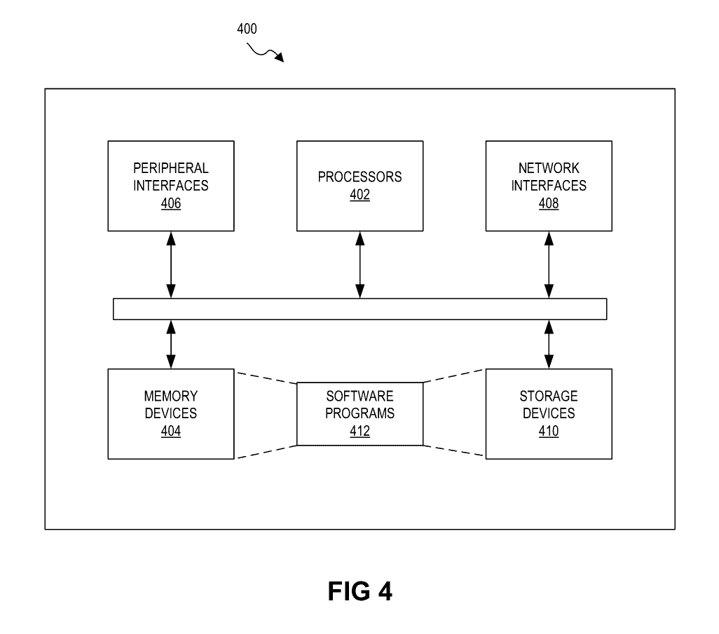

Embodiments of the disclosure may also include one or more systems for implementing one or more embodiments of the method of the present disclosure. FIG. 4 illustrates a schematic view of such a computing or processor system 400, according to an embodiment. The processor system 400 may include one or more processors 402 of varying core (including multiple-core) configurations and clock frequencies. The one or more processors 402 may be operable to execute instructions, apply logic, etc. It will be appreciated that these functions may be provided by multiple processors or multiple cores on a single chip operating in parallel and/or communicably linked together.

The processor system 400 may also include a memory system, which may be or include one or more memory devices and/or computer-readable media 404 of varying physical dimensions, accessibility, storage capacities, etc. such as flash drives, hard drives, disks, random access memory, etc., for storing data, such as images, files, and program instructions for execution by the processor 402. In an embodiment, the computer-readable media 404 may store instructions that, when executed by the processor 402, are configured to cause the processor system 400 to perform operations. For example, execution of such instructions may cause the processor system 400 to implement one or more portions and/or embodiments of the methods 100 described above.

The processor system 400 may also include one or more network interfaces 406. The network interfaces 406 may include any hardware, applications, and/or other software. Accordingly, the network interfaces 406 may include Ethernet adapters, wireless transceivers, PCI interfaces, and/or serial network components, for communicating over wired or wireless media using protocols, such as Ethernet, wireless Ethernet, etc.

The processor system 400 may further include one or more peripheral interfaces 408, for communication with a display screen, projector, keyboards, mice, touchpads, sensors, other types of input and/or output peripherals, and/or the like. In some implementations, the components of processor system 400 need not be enclosed within a single enclosure or even located in close proximity to one another, but in other implementations, the components and/or others may be provided in a single enclosure.

The memory device 404 may be physically or logically arranged or configured to store data on one or more storage devices 410. The storage device 410 may include one or more file systems or databases in any suitable format. The storage device 410 may also include one or more software programs 412, which may contain interpretable or executable instructions for performing one or more of the disclosed processes. When requested by the processor 402, one or more of the software programs 412, or a portion thereof, may be loaded from the storage devices 410 to the memory devices 404 for execution by the processor 402.

Those skilled in the art will appreciate that the above-described componentry is merely one example of a hardware configuration, as the processor system 400 may include any type of hardware components, including any necessary accompanying firmware or software, for performing the disclosed implementations. The processor system 400 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 400 may be used to execute programs according to instructions received from another program or from another processor system altogether. Similarly, commands may be received, executed, and their output returned entirely within the processing and/or memory of the processor system 400. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A method for correlating data, comprising:
displaying a first data set in a primary graph having a time-based axis, wherein the first data set is collected from a machine by a first sensor, and wherein the primary graph comprises a plurality of data points representing the first data set;
receiving a selection of a selected data point of the plurality of data points;
correlating the selected data point with a second data set; and
displaying a secondary graph representing the secondary data set.

2. The method of claim 1, wherein the second data set comprises data collected by a second sensor that is different from the first sensor.

3. The method of claim 2, wherein the first data set comprises vibration data measured at a first point of the machine, and wherein the second data set comprises vibration data measured at a second point of the machine.

4. The method of claim 1, wherein the second data set comprises data in a different domain from the first data.

5. The method of claim 1, wherein the first data set comprises date-time data and the second data set comprises frequency-domain data, waveform data, or a combination thereof.

6. The method of claim 1, further comprising displaying a reference cursor in the primary graph located at the selected data point.

7. The method of claim 6, further comprising:
receiving an adjustment to a position of the reference cursor; and
updating a correlation of the second data set.

8. The method of claim 6, further comprising receiving an input associated with the primary graph or secondary graph, wherein the second data set is correlated based on the selected data point on the primary data set as indicated by the reference cursor.

9. The method of claim 6, further comprising receiving an input moving the reference cursor to a window configured to display the secondary graph, wherein the second data set is correlated based on a location of the reference cursor prior to being moved.

10. A computing system, comprising:
one or more processors; and
a memory system including one or more non-transitory, computer-readable media storing instructions that, when executed by at least one of the one or more processors, cause the computing system to perform operations, the operations comprising:
displaying a first data set in a primary graph having a time-based axis, wherein the first data set is collected from a machine by a first sensor, and wherein the primary graph comprises a plurality of data points representing the first data set;
receiving a selection of a selected data point of the plurality of data points;
correlating the selected data point with a second data set; and
displaying a secondary graph representing the secondary data set.

11. The computing system of claim 10, wherein the second data set comprises data collected by a second sensor that is different from the first sensor.

12. The computing system of claim 11, wherein the first data set comprises vibration data measured at a first point of the machine, and wherein the second data set comprises vibration data measured at a second point of the machine.

13. The computing system of claim 10, wherein the second data set comprises data in a different domain from the first data.

14. The computing system of claim 10, wherein the first data set comprises date-time data and the second data set comprises frequency-domain data, waveform data, or a combination thereof.

15. The computing system of claim 10, wherein the operations further comprise displaying a reference cursor in the primary graph located at the selected data point.

16. The computing system of claim 15, wherein the operations further comprise:
receiving an adjustment to a position of the reference cursor; and
updating a correlation of the second data set.

17. The computing system of claim 16, wherein the operations further comprise receiving an input associated with the primary graph or secondary graph, wherein the second data set is correlated based on the selected data point on the primary data set as indicated by the reference cursor.

18. The computing system of claim 16, wherein the operations further comprise receiving an input moving the reference cursor to a window configured to display the secondary graph, wherein the second data set is correlated based on a location of the reference cursor prior to being moved.

19. A non-transitory, computer-readable medium storing instructions that, when executed by at least one processor of a computing system, cause the computing system to perform operations, the operations comprising:
displaying a first data set in a primary graph having a time-based axis, wherein the first data set is collected from a machine by a first sensor, and wherein the primary graph comprises a plurality of data points representing the first data set;
receiving a selection of a selected data point of the plurality of data points;
correlating the selected data point with a second data set; and
displaying a secondary graph representing the secondary data set.

20. The medium of claim 19, wherein:
the second data set comprises data collected by a second sensor that is different from the first sensor;
the first data set comprises vibration data measured at a first point of the machine, and the second data set comprises vibration data measured at a second point of the machine; and
the second data set comprises data in a different domain from the first data.
